(19) United States
(12) Patent Application Publication
(10) Pub. No.: US 2026/0167240 A1
(43) Pub. Date: Jun. 18, 2026

(54) CAMPING VEHICLE

(71) Applicant: Zhongshan powerlink baby products Co.,Ltd, Zhongshan (CN)

(72) Inventor: MING LEI, Zhongshan (CN)

(21) Appl. No.: 19/293,552

(22) Filed: Aug. 7, 2025

(30) Foreign Application Priority Data
Dec. 13, 2024 (CN) 202423085575.6

(51) Int. Cl. B62B 3/02; B62B 5/06

(52) U.S. Cl. CPC B62B 3/02; B62B 5/061; B62B 2205/06; B62B 2501/06

(57) ABSTRACT

The present invention relates to the field of camping equipment, and in particular to a camping vehicle. The camping vehicle comprises a vehicle body, wherein one side of the vehicle body is provided with cross beams, two ends of the cross beams are provided with vertical beams, a backrest is rotatably mounted on the cross beams, a sliding rod is vertically slidably mounted on the backrest, hinged rods are rotatably mounted on the vertical beams, and the hinged rods are rotatably connected to the sliding rod. The camping vehicle provided by the invention has the advantages of an adjustable backrest and comfortable riding.

### CROSS-REFERENCE TO RELATED APPLICATIONS

This application claims priority to Chinese Patent Application No. 202423085575.6 , filed on December 13, 2024, which is hereby incorporated by reference in its entirety.

### TECHNICAL FIELD

The present invention relates to the field of camping equipment, and in particular to a camping vehicle.

### BACKGROUND

Camping has become a common way for people to relax and have fun. When camping, some parents will put their child in a camping cart to walk, but existing camping carts do not have a backrest and are not comfortable to ride.

For example, a patent document with an announcement number CN221477135U discloses a camping vehicle, comprising a moving component, an X-shaped support folding component, an X-shaped connecting component and a load-bearing bottom rod; the moving component comprises a front wheel and a universal wheel, the front wheel is mounted at a front end of the X-shaped support folding component, and the universal wheel is mounted at a rear end of the X-shaped support folding component; wherein a surface of the front wheel is covered with a conducting body, the front wheel is rotatably connected to a frame, the front wheel can pivot and roll in the frame, a magnetic-body frame is provided in the frame, the magnetic-body frame is located on an upper side of the front wheel, one side of the magnet frame close to the front wheel is provided with a magnet, and the magnetic-body frame can be raised and lowered in the frame to adjust a distance between the magnetic-body frame and the front wheel.

For another example, a patent document with an announcement number CN214296089U discloses an electric camping vehicle, which belongs to the technical field of cargo carrying tools. The electric camping vehicle comprises: a frame, a bottom end of the frame being rotatably provided with a driving wheel, and the frame being also provided with a driving device for driving the driving wheel to rotate; a cargo carrying component, one end of the cargo carrying component being rotatably connected to a top part of one end of the frame, and a bottom end of another end of the cargo carrying component being rotatably provided with at least two driven wheels; and a hand-holding component, one end of the hand-holding component being detachably connected to another end of the frame.

Therefore, a camping vehicle is proposed to solve the above technical problems..

### SUMMARY

In order to solve the above technical problems, the purpose of the invention is to provide a camping vehicle with the advantages of an adjustable backrest and comfortable riding.

A technical solution adopted by the invention to solve the problems is: a camping vehicle, comprising: a vehicle body, wherein one side of the vehicle body is provided with cross beams, two ends of the cross beams are provided with vertical beams, a backrest is rotatably mounted on the cross beams, a sliding rod is vertically slidably mounted on the backrest, hinged rods are rotatably mounted on the vertical beams, and the hinged rods are rotatably connected to the sliding rod.

As a further improvement of the above technical solution, two limiting parts are further comprised, the limiting parts comprise sliding members, the sliding members are slidably connected to the backrest, the sliding members are fixedly mounted at end parts of the sliding rod, sliding blocks are slidably mounted in the sliding members, end parts of the sliding blocks are provided with pin shafts, a plurality of clamping holes are provided on the backrest, and the clamping holes are fitted with the pin shafts.

As a further improvement of the above technical solution, springs are provided in the sliding blocks, first connecting shafts are provided on the sliding members, the first connecting shafts abut against the springs, the sliding rod is of a hollow structure, sleeve pipes are slidably mounted outside the sliding rod, slots are provided on the sliding rod, second connecting shafts are slidably mounted in the slots, the second connecting shafts are connected to the sleeve pipes, steel wire ropes are provided in the sliding rod, and two ends of the steel wire ropes are fixedly connected to the sliding blocks and the sleeve pipes respectively.

As a further improvement of the above technical solution, the vehicle body comprises two scissor lift structures, top ends of the scissor lift structures are provided with sliding sleeves, and the sliding sleeves are slidably connected to the corresponding vertical beams.

As a further improvement of the above technical solution, an avoidance hole is provided between two adjacent cross beams, a cover plate is movably provided on the avoidance hole, surrounding cloth is further comprised, a bottom part of the surrounding cloth is provided with an extension part, and the extension part extends downward through the avoidance hole.

As a further improvement of the above technical solution, a ceiling is further comprised, the ceiling comprises a connecting member, a top part of the connecting member is provided with four grooves, support rods are rotatably mounted in the grooves, one end of the support rods are provided with transfer blocks, bottom parts of the transfer blocks are provided with sleeves, top ends of the vertical beams are provided with insertion rods, the insertion rods are fitted with the sleeves, and bottom parts of the support rods are provided with a tarpaulin.

As a further improvement of the above technical solution, the support rods are rotatably connected to the grooves through spring hinges.

As a further improvement of the above technical solution, fixing blocks are fixedly provided on the insertion rods, the fixed blocks are provided below the sliding sleeve, the fixing blocks are fixedly connected with connecting belts, the surrounding cloth is movably connected with two connecting rings, the two connecting rings are provided between the two adjacent insertion rods in front and back, and one end of the connecting belts pass through a rear side of the two connecting rings and then pass out from between the two connecting rings.

As a further improvement of the above technical solution, one side of the vehicle body away from the cross beams is provided with a push handle.

As a further improvement of the above technical solution, a pull handle is rotatably mounted on the cross beams, and the pull handle is retractable.

The beneficial effects of the invention are that: a backrest is provided, and the backrest is adjustable, thus being convenient for riding and improving riding comfort.

### BRIEF DESCRIPTION OF THE DRAWINGS

The present invention will be further explained below in conjunction with the description of the accompanying drawings and specific embodiments.

FIG. 1 is a structural schematic diagram of a preferred embodiment of the present invention;

FIG. 2 is a schematic diagram of a partial structure shown in FIG. 1;

FIG. 3 is an exploded view of a partial structure of the present invention;

FIG. 4 is a structural view of surrounding cloth and a cover plate in the present invention;

FIG. 5 is a structural view of a ceiling in the present invention;

FIG. 6 is a stereoscopic view of a vehicle body of the present invention after the surrounding cloth is mounted.

In the figures: 1, vehicle body; 11, cross beam; 12, vertical beam; 13, avoidance hole; 14, cover plate; 15, scissor lift structure; 16, sliding sleeve; 17, insertion rod; 171, fixing block; 2, backrest; 21, clamping hole; 3, sliding rod; 31, slot; 32, second connecting shaft; 4, hinged rod; 5, limiting part; 51, sliding member; 52, sliding block; 53, pin shaft; 54, spring; 55, first connecting shaft; 56, sleeve pipe; 57, wire rope; 6, pull handle; 7, surrounding cloth; 71, extension part; 8, ceiling; 81, connecting member; 82, groove; 83, support rod; 84, transfer block; 85, sleeve; 91, connecting ring; 92, connecting bel.

### DESCRIPTION OF EMBODIMENTS

This section will describe the specific embodiments of the present invention in detail. The preferred embodiments of the present invention are shown in the accompanying drawings. The function of the accompanying drawings is to supplement the statement of the text part of the description with graphics, so that people can intuitively and vividly understand each technical feature and overall technical solution of the present invention. However, the accompanying drawings shall not be construed as a limitation to the protection scope of the present invention.

In the statement of the present invention, it should be understood that orientation statements, such as orientation or position relationships indicated by up, down, front, back, left, right, etc., are based on the orientation or position relationships shown in the accompanying drawings and are only to facilitate the statement of the present invention and simplify the statement, rather than indicate or imply that the device or element referred to must have a specific orientation, be constructed and operate in a specific orientation, and therefore should not be understood as a limitation to the present invention.

In the statement of the present invention, “several” means one or more, “a plurality of” means two or more, “greater than”, “less than”, and “more than”, etc. are understood to exclude the original number, and above, below, within, etc. are understood to include the original number. "First", "second", etc., if described, are for the purpose of distinguishing technical features only, but should not be understood as indicating or implying a relative importance or implicitly indicating the number of technical features indicated or implicitly indicating the precedence of technical features indicated.

In the statement of the present invention, unless otherwise explicitly specified, words such as setting, mounting and connection should be understood in a broad sense. Those skilled in the art can reasonably determine the specific meanings of the above words in the present invention in combination with the specific content of the technical solution.

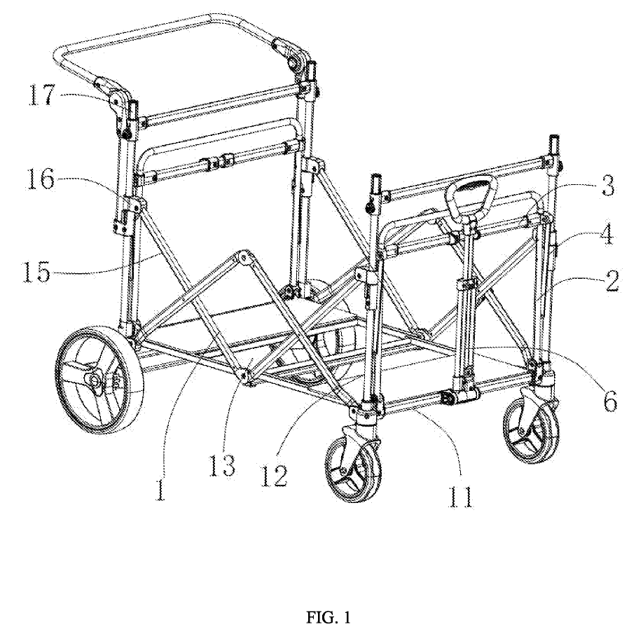

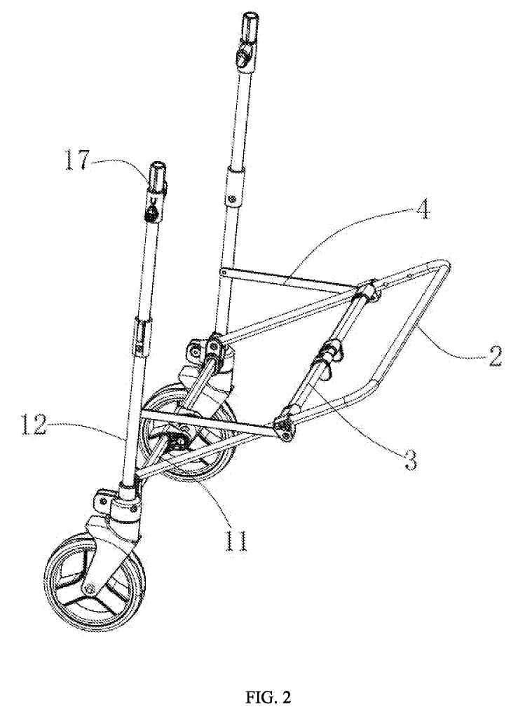

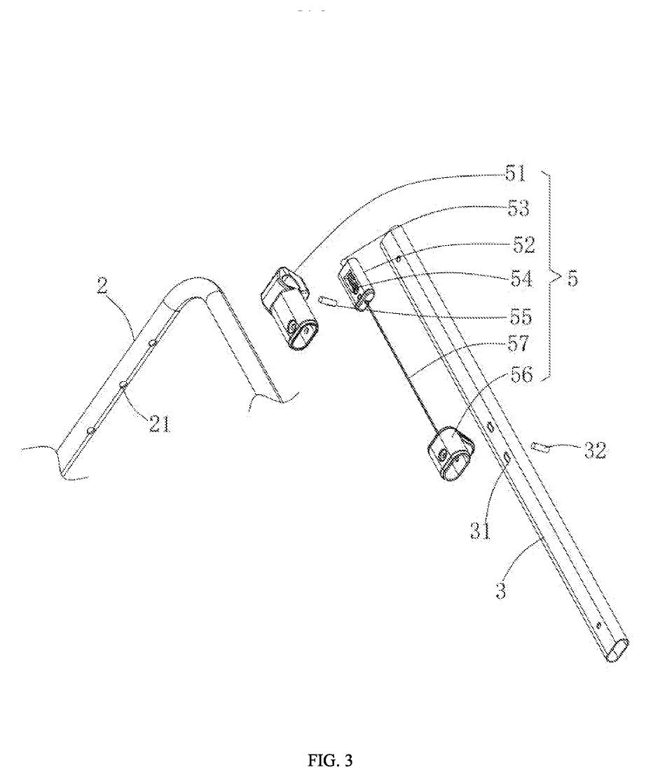

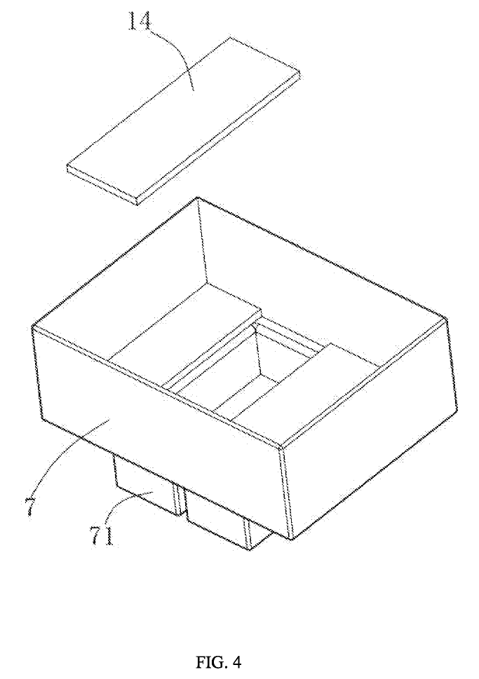

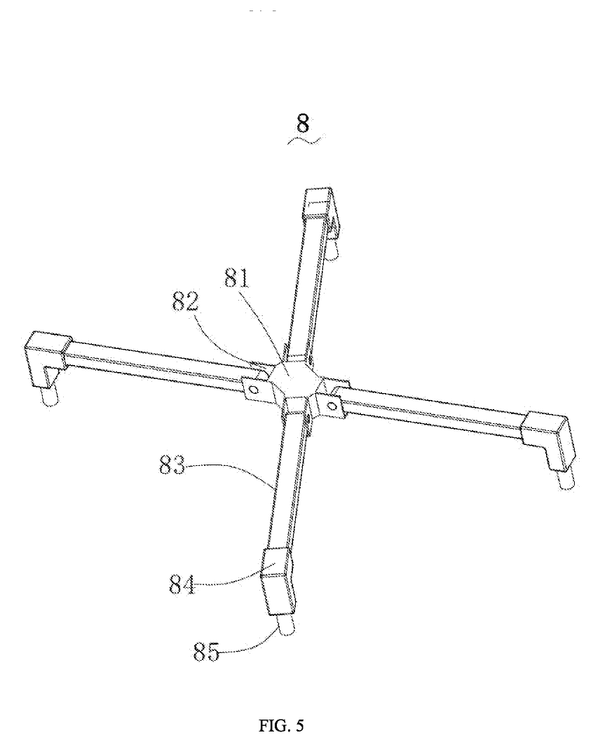

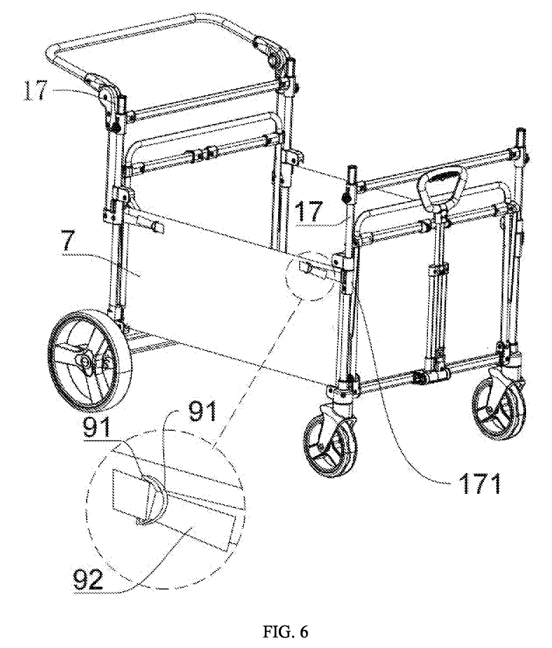

Referring to FIG. 1 to FIG. 6, a camping vehicle comprises: a vehicle body 1, wherein one side of the vehicle body 1 is provided with cross beams 11, two ends of the cross beams 11 are provided with vertical beams 12, a backrest 2 is rotatably mounted on the cross beams 11, a sliding rod 3 is vertically slidably mounted on the backrest 2, hinged rods 4 are rotatably mounted on the vertical beams 12, and the hinged rods 4 are rotatably connected to the sliding rod 3. An angle of the backrest 2 can be adjusted, thus improving riding comfort, and when the backrest 2 is rotated, the hinged rods 4 can drive the sliding rod 3 to slide on the backrest 2.

As a preferred embodiment, two limiting parts 5 are further comprised, the limiting parts 5 comprise sliding members 51, the sliding members 51 are slidably connected to the backrest 2, the sliding members 51 are fixedly mounted at end parts of the sliding rod 3, sliding blocks 52 are slidably mounted in the sliding members 51, end parts of the sliding blocks 52 are provided with pin shafts 53, a plurality of clamping holes 21 are provided on the backrest 2, and the clamping holes 21 are fitted with the pin shafts 53. When the backrest 2 is adjusted, the sliding rod 3 can slide on the backrest 2, and the sliding blocks 52 are used to drive the pin shafts 53 to be inserted into the corresponding clamping holes 21, and thus angle adjustment of the backrest 2 can be achieved.

As a preferred embodiment, springs 54 are provided in the sliding blocks 52, first connecting shafts 55 are provided on the sliding members 51, the first connecting shaft 55 abuts against the springs 54, the sliding rod 3 is of a hollow structure, sleeve pipes 56 are slidably mounted outside the sliding rod 3, slots 31 are provided on the sliding rod 3, second connecting shafts 32 are slidably mounted in the slots 31, the second connecting shafts 32 are connected to the sleeve pipes 56, steel wire ropes 57 are provided in the sliding rod 3, and two ends of the steel wire ropes 57 are fixedly connected to the sliding blocks 52 and the sleeve pipes 56 respectively. By manually controlling the sleeve pipes 56 to slide, the steel wire rope 57 can be used to drive the sliding blocks 52 to slide, thereby controlling the pin shafts 53 to move. When the sliding blocks 52 are pulled to move, the springs 54 store energy. Conversely, after the sleeve pipes 56 are released, the sliding blocks 52 can drive the pin 53 to reset under an elastic force of the springs 54. Thus, the sleeve pipes 56 can be manually controlled, enabling inter-locking of the sliding blocks 52 and different clamping holes 21 to adjust the angle of the backrest 2.

As a preferred embodiment, the vehicle body 1 comprises two scissor lift structures 15, top ends of the scissor lift structures 15 are provided with sliding sleeves 16, and the sliding sleeves 16 are slidably connected to the corresponding vertical beams 12. The vehicle body 1 can be folded, being convenient for carrying.

As a preferred embodiment, an avoidance hole 13 is provided between two adjacent cross beams 11, a cover plate 14 is movably provided on the avoidance hole 13, surrounding cloth 7 is also comprised, a bottom part of the surrounding cloth 7 is provided with an extension part 71, and the extension part 71 extends downward through the avoidance hole 13. This arrangement allows a person to sit in the vehicle body 1 with his/her legs placed in the extension part 71 through the avoidance hole 13, and comfortable riding can be ensured.

As a preferred embodiment, a ceiling 8 is further comprised, the ceiling 8 comprises a connecting member 81, a top part of the connecting member 81 is provided with four grooves 82, support rods 83 are rotatably mounted in the grooves 82, one end of the support rods 83 are provided with transfer blocks 84, bottom parts of the transfer block 84 are provided with sleeves 85, top ends of the vertical beams 11 are provided with insertion rods 17, the insertion rods 17 are fitted with the sleeves 85, and bottom parts of the support rods 83 are provided with a tarpaulin (not shown in the figure). In case that it is raining or sun shading is needed, the support rods 83 are rotated and opened upward to unfold the tarpaulin, and the sleeves 85 are provided on the insertion rods 17 in a sleeving manner, so that the ceiling 8 is mounted on the vehicle body 1, which can achieve rain shielding and sun shading.

As a preferred embodiment, the support rods 83 are rotatably connected to the grooves 82 through spring hinges. After the sleeves 85 are separated from the insertion rod 17, the support rods 83 can be automatically retracted and folded under the action of the spring hinges, and the operation is simple and convenient.

As a preferred embodiment, fixing blocks 171 are fixedly provided on the insertion rods 17, and the fixing blocks 171 are arranged below the sliding sleeves 16. the fixing blocks 171 are fixedly connected with connecting belts 92, the surrounding cloth 7 is movably connected with two connecting rings 91, the two connecting rings 91 are provided between the two adjacent insertion rods 17 in front and back, and one end of the connecting belts 92 pass through a rear side of the two connecting rings 91 and then pass out from between the two connecting rings 91. The connecting rings 91 and the connecting belts 92 are fixed to each other by friction force, and by adjusting connection positions of the connecting rings 91 and the connecting belts 92, the surrounding cloth 7 can be adaptively adjusted after angles of the vertical beams 11 are changed.

As a preferred embodiment, one side of the vehicle body 1 away from the cross beams 11 is provided with a push handle.

As a preferred embodiment, a pull handle 6 is rotatably mounted on the cross beams 11, and the pull handle 6 is retractable.

The above are only preferred embodiments of the present invention, and are not intended to limit the patent scope of the present invention. Under the invention concept of the present invention, equivalent structural transformations made using the contents of the description and drawings of the present invention, or directly or indirectly used in other relevant technical fields are all included in the patent protection scope of the present invention.

What is claimed is:

1. A camping vehicle, comprising:
a vehicle body (1), wherein one side of the vehicle body (1) is provided with cross beams (11), two ends of the cross beams (11) are provided with vertical beams (12), a backrest (2) is rotatably mounted on the cross beams (11) or the vertical beams (12), a sliding rod (3) is vertically slidably mounted on the backrest (2), hinged rods (4) are rotatably mounted on the vertical beams (12), and the hinged rods (4) are rotatably connected to the sliding rod (3).

2. The camping vehicle according to claim 1,
further comprising two limiting parts (5), wherein the limiting parts (5) comprise sliding members (51), the sliding members (51) are slidably connected to the backrest (2), the sliding members (51) are fixedly mounted at end parts of the sliding rod (3), sliding blocks (52) are slidably mounted in the sliding members (51), end parts of the sliding blocks (52) are provided with pin shafts (53), a plurality of clamping holes (21) are provided on the backrest (2), and the clamping holes (21) are fitted with the pin shafts (53).

3. The camping vehicle according to claim 2, wherein
springs (54) are provided in the sliding blocks (52), first connecting shafts (55) are provided on the sliding members (51), the first connecting shafts (55) abut against the springs (54), the sliding rod (3) is of a hollow structure, sleeve pipes (56) are slidably mounted outside the sliding rod (3), slots (31) are provided on the sliding rod (3), second connecting shafts (32) are slidably mounted in the slots (31), the second connecting shafts (32) are connected to the sleeve pipes (56), steel wire ropes (57) are provided in the sliding rod (3), and two ends of the steel wire ropes (57) are fixedly connected to the sliding blocks (52) and the sleeve pipes (56), respectively.

4. The camping vehicle according to claim 1, wherein
the vehicle body (1) comprises two scissor lift structures (15), top ends of the scissor lift structures (15) are provided with sliding sleeves (16), and the sliding sleeves (16) are slidably connected to the corresponding vertical beams (12).

5. The camping vehicle according to claims claim 1, wherein
an avoidance hole (13) is provided between two adjacent cross beams (11), a cover plate (14) is movably provided on the avoidance hole (13), surrounding cloth (7) is further comprised, a bottom part of the surrounding cloth (7) is provided with an extension part (71), and the extension part (71) extends downward through the avoidance hole (13).

6. The camping vehicle according to claim 5,
further comprising a ceiling (8), wherein the ceiling (8) comprises a connecting member (81), a top part of the connecting member (81) is provided with four grooves (82), support rods (83) are rotatably mounted in the grooves (82), one end of the support rods (83) are provided with transfer blocks (84), bottom parts of the transfer blocks (84) are provided with sleeves (85), top ends of the vertical beams (11) are provided with insertion rods (17), the insertion rods (17) are fitted with the sleeves (85), and bottom parts of the support rods 83 are provided with a tarpaulin.

7. The camping vehicle according to claim 6, wherein
the support rods (83) are rotatably connected to the grooves (82) through spring hinges.

8. The camping vehicle according to claim 6, wherein
fixing blocks (171) are fixedly provided on the insertion rods (17), the fixing blocks (171) are provided below the sliding sleeves (16), the fixing blocks (171) are fixedly connected with connecting belts (92), the surrounding cloth (7) is movably connected with two connecting rings (91), the two connecting rings (91) are arranged between the two adjacent insertion rods (17) in front and back, and one end of the connecting belts (92) pass through a rear side of the two connecting rings (91) and then pass out from between the two connecting rings (91).

9. The camping vehicle according to claim 1, wherein
one side of the vehicle body (1) away from the cross beams (11) is provided with a push handle.

10. The camping vehicle according to claim 9, wherein
a pull handle (6) is rotatably mounted on the cross beams (11), and the pull handle (6) is retractable.
